(19) United States
(12) Patent Application Publication
(10) Pub. No.: US 2022/0040629 A1
(43) Pub. Date: Feb. 10, 2022

(54) PITCH DESTRUCTION PROCESSES USING THERMAL OXIDATION SYSTEM

(71) Applicant: Honeywell International Inc., Charlotte, NC (US)

(72) Inventors: Nicholas R. Edmoundson, Tulsa, OK (US); William J. Whyman, Tulsa, OK (US); Randall Tucker Watts, Tulsa, OK (US); Kenny M. Arnold, Broken Arrow, OK (US); Jagannathan Govindhakannan, Des Plaines, IL (US); Gary R. Brierley, Crystal Lake, IL (US); Christopher J. Anderle, Roselle, IL (US); Mark Van Wees, Des Plaines, IL (US); Jan De Ren, Bracknell (GB)

(21) Appl. No.: 17/362,503

(22) Filed: Jun. 29, 2021

Related U.S. Application Data
(60) Provisional application No. 63/155,876, filed on Mar. 3, 2021.
(60) Provisional application No. 63/060,805, filed on Aug. 4, 2020.

(51) Int. Cl. B01D 53/14; C10G 67/14; B01D 53/50; B01D 53/78; B01D 53/56; B01D 3/14

(52) U.S. Cl. CPC B01D 53/1481; B01D 2251/604; B01D 53/1493; B01D 53/145; B01D 53/502; B01D 53/507; B01D 53/78; B01D 53/56; B01D 3/143; C10G 2300/207; C10G 2300/4018; C10G 2300/4006; C10G 2300/4012; C10G 2300/205; B01D 2252/102; B01D 2251/304; C10G 67/14

(57) ABSTRACT

Processes for the treatment of waste streams from the hydroconversion of heavy hydrocarbons containing additives and catalysts are described. At least one of the SHC pitch stream, SDA pitch stream, and the heavy residue stream is sent to a thermal oxidation system. The metals in the SHC and SDA pitch streams and the heavy residue stream are oxidized and can be easily recovered as clean powdered metal oxides which can be reused or sold. The processes produce chemicals which can be recovered and sold.

### RELATED APPLICATIONS

This application claims the benefit of U.S. Provisional Patent Application Ser. Nos. 63/060,805 filed on Aug. 4, 2020, and 63/155,876 filed Mar. 3, 2021, the entirety of which are incorporated herein by reference.

### BACKGROUND

Hydroconversion processes for the conversion of heavy hydrocarbon oils to light and intermediate naphthas of good quality and for reforming feedstocks, fuel oil and gas oil are well known. These heavy hydrocarbon oils can be such materials as petroleum crude oil, atmospheric tower bottoms products, vacuum tower bottoms products, heavy cycle oils, shale oils, coal-derived liquids, crude oil residuum, topped crude oils and the heavy bituminous oils produced from oil sands. The heavy hydrocarbon oils contain wide boiling range materials from naphthas through kerosene, gas oil, pitch, etc., and which contain a large portion of material boiling above 538° C. (1000° F.).

As the reserves of conventional crude oils decline, these heavy oils must be upgraded to meet demands. In this upgrading, the heavier materials are converted to lighter fractions and most of the sulfur, nitrogen and metals must be removed. Crude oil is typically first processed in an atmospheric crude distillation tower to provide fuel products including naphtha, kerosene and diesel. The atmospheric crude distillation tower bottoms stream is typically taken to a vacuum distillation tower to obtain vacuum gas oil (VGO) that can be feedstock for a fluid catalytic cracking (FCC) unit or other uses. VGO typically boils in a range between at or about 300° C. (572 F) and at or about 538° C. (1000° F.). The vacuum bottoms are usually processed in a primary upgrading unit before being sent further to a refinery to be processed into useable products. One process for upgrading the vacuum bottoms is slurry hydrocracking (SHC) which enables conversion of crude oil vacuum bottoms to VGO and lighter products. SHC produces a pitch byproduct at a yield of approximately 5-20 wt-% on an ash-free basis. Pitch is the hydrocarbon material boiling above 538° C. (1000° F.) atmospheric equivalent as determined by any standard gas chromatographic simulated distillation method such as ASTM D2887, D6352 or D7169, all of which are used by the petroleum industry. The pitch byproduct is solid at room temperature and has minimum pumping temperatures in excess of 250° C. It has a very low commercial value due to its high viscosity, portability difficulties, and high levels of undesired components, such as sulfur contaminants and a slurry hydrocracking catalyst used during the cracking of the feedstock. The pitch must be treated and disposed of.

Solvent deasphalting (SDA) is another process for upgrading heavy oils. SDA generally refers to refinery processes that upgrade hydrocarbon fractions using extraction in the presence of a solvent. SDA permits practical recovery of heavier oil, at relatively low temperatures, without cracking or degradation of heavy hydrocarbons. SDA separates hydrocarbons according to their solubility in a liquid solvent, as opposed to volatility in distillation. Lower molecular weight and more paraffinic components are preferentially extracted. The least soluble materials are high molecular weight and most polar aromatic components. The process produces deasphalted oil (DAO), optionally resin, and SDA pitch. SDA pitch yield is about 50% of the feedstock. It contains most of the metals and must be treated and/or disposed of.

Therefore, there is a need for an improved method of treating waste pitch streams. It would also be desirable to reduce the costs of the processes by eliminating equipment or reducing the size of equipment in the process.

### BRIEF DESCRIPTION OF THE DRAWINGS

FIG. 1 is an illustration of one embodiment of a conventional slurry hydrocracking process.

FIG. 2 is an illustration of one embodiment of a slurry hydrocracking process according to the present invention.

FIG. 3 is an illustration of a conventional solvent deasphalting process.

FIG. 4 is an illustration of a solvent deasphalting process according to the present invention.

FIG. 5 is an illustration of one embodiment of the treatment of the SHC pitch stream, SDA pitch stream, and heavy residue stream in a thermal oxidation system.

FIG. 6 is an illustration of one embodiment of a thermal oxidation system.

FIG. 7 is an illustration of another embodiment of a thermal oxidation system.

FIG. 8 is an illustration of one embodiment of the thermal oxidation system of FIG. 6 with improved energy recovery.

FIG. 9 is an illustration of one embodiment of the thermal oxidation system of FIG. 7 with improved energy recovery.

FIGS. 10A-C are illustrations of different embodiments of a thermal oxidizing section.

### DETAILED DESCRIPTION

This invention relates to processes for the treatment of waste streams from the hydroconversion of heavy hydrocarbons containing additives and catalysts. It involves processes for treating at least one of SHC pitch, SDA pitch, and heavy residue. Heavy residue is heavy hydrocarbon oil, including but not limited to, petroleum crude oil, atmospheric tower bottoms products, vacuum tower bottoms products, heavy cycle oils, shale oils, coal-derived liquids, crude oil residuum, topped crude oils and the heavy bituminous oils produced from oil sands. Heavy residue contains wide boiling range materials from naphthas through kerosene, gas oil, pitch, etc., and contains a large portion of material boiling above 538° C. (1000° F.). The processes allow for the elimination of one or more of the current pitch treatment systems, resulting in lower capital and operating costs.

At least one of the SHC pitch stream, SDA pitch stream, and the heavy residue stream is sent to a thermal oxidation system. The metals in the pitch streams and heavy residue stream are oxidized and can be easily recovered as clean powdered metal oxides which can be reused or sold. Furthermore, the processes produce chemicals which can be recovered and sold.

The processes can have improved environmental outcomes. In some embodiments, a selective non-catalytic reduction (SNCR) section in the thermal oxidizing section reduces nitrous oxides (NOx) in the flue gas for cleaner emissions. In addition, vanadium oxide entrained in the flue gas acts as a catalyst when ammonia is injected into the gas stream, which also reduces NOx.

Process water can be used as a quench stream in the thermal oxidation system without pretreatment, reducing overall water usage.

The processes eliminate the pitch treatment section for SHC and SDA plants, reducing capital costs. In addition, one or more sour water streams may optionally be sent to the thermal oxidation system, allowing reduction in the size or elimination of the sour water stripper (SWS) system and/or waste water treatment plant, further reducing capital costs.

Waste heat can be recovered from the flue gas when a boiler is included in the system. The recovered waste heat can be used in other parts of the process or plant, reducing operating costs

One aspect of the invention is a process for treating effluent streams in a process. In one embodiment, the process comprises: thermally oxidizing at least one of a pitch stream from a slurry hydrocracking fractionation section, a pitch stream from a solvent deasphalting separation section, and a heavy residue stream in a thermal oxidation system, comprising: thermally oxidizing the at least one of the pitch stream from the slurry hydrocracking fractionation section, the pitch stream from the solvent deasphalting separation section, and the heavy residue stream in a thermal oxidizing section forming flue gas consisting essentially of at least one of H₂O, CO₂, N₂, O₂, SOx, NOx, and oxidized metal particulate; recovering waste heat from the flue gas in a waste heat recovery section; filtering the flue gas in the filtration section to remove the oxidized metal particulate forming a filtered flue gas and a particulate stream comprising the oxidized metal particulate; removing SOx from the flue gas in a SOx removal section to form a de-SOx outlet flue gas consisting essentially of at least one of H₂O, CO₂, N₂, O₂, NOx, wherein removing the SOx from the flue gas comprises: quenching the flue gas to form quenched flue gas after recovering the waste heat; and contacting a caustic solution or an NH₃ based solution with the quenched flue gas in scrubbing section to form the de-SOx outlet flue gas and a liquid stream comprising at least one of H₂O, Na₂SO₃, Na₂SO₄, NaHSO₃, Na₂CO₃, and (NH₄)₂SO₄; or reacting the flue gas with a reactant in an SOx reaction section to form a reaction section flue gas consisting essentially of at least one of H₂O, CO₂, N₂, O₂, Na₂CO₃, Na₂SO₄, NaNO₃, CaSO₄, CaCO₃, Ca(NO₃)₂, MgCO₃, MgSO₄, Mg(NO₃)₂, NOx, wherein the reactant comprises at least one of NaHCO₃, NaHCO₃.Na₂CO₃.2(H₂O), CaCO₃, Ca(OH)₂, and Mg(OH)₂; and filtering the reaction section flue gas in a filtration section to remove Na₂CO₃, Na₂SO₄, NaNO₃, CaSO₄, CaCO₃, Ca(NO₃)₂, MgCO₃, MgSO₄, and Mg(NO₃)₂ to form the de-SOx outlet flue gas and a dry residue stream comprising at least one of Na₂CO₃, Na₂SO₄, NaNO₃, CaSO₄, CaCO₃, Ca(NO₃)₂, MgCO₃, MgSO₄, and Mg(NO₃)₂; optionally removing NOx from the de-SOx outlet flue gas in a NOx removal section to form a de-NOx outlet flue gas consisting essentially of at least one of H₂O, CO₂, N₂, and O₂. By thermally oxidizing a specified stream, we mean that the thermally oxidizable, i.e. hydrocarbon components in the stream are thermally oxidized. For example, with the phenolic or non-phenolic water streams, the thermally oxidizable components in the phenolic or non-phenolic streams are thermally oxidized; the water is evaporated.

In some embodiments, the process further comprises: recovering at least one of the particulate stream from the filtration section and the dry residue stream from the SOx removal section.

In some embodiments, the oxidized metal particulate comprises oxidized vanadium, nickel, molybdenum, and combinations thereof.

In some embodiments, the process further comprises at least one of: heating at least one of the pitch stream from the slurry hydrocracking fractionation section, the pitch stream from the solvent deasphalting separation section, and the heavy residue stream; introducing a diluent into at least one of the pitch stream from the slurry hydrocracking fractionation section, the pitch stream from the solvent deasphalting separation section, and the heavy residue stream; and atomizing at least one of the pitch stream from the slurry hydrocracking fractionation section, the pitch stream from the solvent deasphalting separation section, and the heavy residue stream.

In some embodiments, the diluent comprises a diesel stream, a light or heavy fluid catalytic cracking oil stream, a kerosene stream, a heavy vacuum gas oil stream, or combinations thereof.

In some embodiments, the process further comprises: thermally oxidizing at least one of a sour water stream from a slurry hydrocracking separation section, a sour water stream from a catalyst addition section, a phenolic sour water stream from a slurry hydrocracking sour water stripper system, a stripped sour water stream from a slurry hydrocracking sour water stripper system, a sour water stream from a slurry hydrocracking fractionation section, a sour water stream from a solvent deasphalting separation section, and a stripped sour water stream from a solvent deasphalting sour water stripping system.

In some embodiments, the process further comprises at least one of; passing the pitch stream from the slurry hydrocracking fractionation section to a slurry hydrocracking storage vessel, and wherein thermally oxidizing the pitch stream from the slurry hydrocracking fractionation section comprises thermally oxidizing a heated pitch stream from a heated slurry hydrocracking storage vessel; passing the pitch stream from the solvent deasphalting separating section to a heated solvent deasphalting storage vessel, and wherein thermally oxidizing the pitch stream from the solvent deasphalting separation section comprises thermally oxidizing a heated pitch stream from a solvent deasphalting storage vessel; and passing the heavy residue stream to a heated heavy residue storage vessel, and wherein thermally oxidizing the heavy residue stream comprises thermally oxidizing a heated heavy residue stream from the feed storage vessel.

In some embodiments, the process further comprises at least one of: passing the heated pitch stream from the heated slurry hydrocracking storage vessel to a hot slurry hydrocracking pitch buffer vessel, and wherein thermally oxidizing the pitch stream from the slurry hydrocracking fractionation section comprises thermally oxidizing a hot pitch stream from the hot slurry hydrocracking pitch buffer vessel; passing the heated pitch stream from the heated solvent deasphalting storage vessel to a hot solvent deasphalting pitch buffer vessel, and wherein thermally oxidizing the pitch stream from the solvent deasphalting section comprises thermally oxidizing a hot pitch stream from the hot solvent deasphalting pitch buffer vessel; and passing the heated heavy residue stream from the heated heavy residue storage vessel to a hot heavy residue buffer vessel, and wherein thermally oxidizing the heavy residue stream comprises thermally oxidizing a hot heavy residue stream from the hot heavy residue buffer vessel.

In some embodiments, the process further comprises at least one of: recycling a portion of the pitch stream from the hot slurry hydrocracking pitch buffer vessel to the slurry hydrocracking storage vessel, the hot slurry hydrocracking storage vessel, or both; recycling a portion of the pitch stream from the hot solvent deasphalting pitch buffer vessel to the solvent deasphalting pitch storage vessel, the hot solvent deasphalting pitch buffer vessel, or both; and recycling a portion of the heavy residue stream from the hot heavy residue buffer vessel to the heavy residue storage vessel, the hot heavy residue buffer vessel, or both.

In some embodiments, the process further comprises: providing the recovered waste heat to at least one piece of equipment in the slurry hydrocracking process or the solvent deasphalting process.

In some embodiments, the process further comprises: introducing at least one of ammonia and urea into a selective non-catalytic reduction section in the thermal oxidizing section to remove NOx, into the NOx removal section to remove NOx from the de-SOx outlet flue gas, or both.

In some embodiments, the process further comprises thermally oxidizing at least one of: a degassing drum vent gas from a separation section of a slurry hydrocracking process, a phenolic SWS tank vent gas stream from a SWS system of the slurry hydrocracking process, and a combined off-gas stream from the SWS system of the slurry hydrocracking process.

In some embodiments, the process comprises thermally oxidizing the pitch stream from the slurry hydrocracking fractionation section, and further comprises: introducing a feed stream containing a slurry hydrocracking catalyst into a slurry hydrocracking reaction section to produce a slurry hydrocracking effluent; separating the slurry hydrocracking effluent into a flash gas stream, a degassing vent gas stream, and a bottoms stream; fractionating the bottoms stream in the slurry hydrocracking fractionation section into a pitch stream and at least one of a naphtha stream, a diesel stream, a light vacuum gas oil stream, and a heavy vacuum gas oil stream; sending a first portion of the pitch stream to the thermal oxidation system, wherein thermally oxidizing the pitch stream from the slurry hydrocracking fractionation section comprises thermally oxidizing the first portion of the pitch stream; and optionally sending a second portion of the pitch stream to the slurry hydrocracking reaction section.

In some embodiments, the process comprises thermally oxidizing the pitch stream from the solvent deasphalting separation section, and further comprising: separating a solvent deasphalting feed stream in an extraction section into a first stream comprising deasphalted oil, resin, and solvent and a second stream comprising solvent deasphalting pitch and solvent; separating the first stream and the second in a solvent deasphalting separation section into at least a pitch stream and a deasphalted oil stream; and sending the pitch stream to the thermal oxidizing section.

In some embodiments, the process further comprises: thermally oxidizing a sour water stream from the solvent deasphalting separation section.

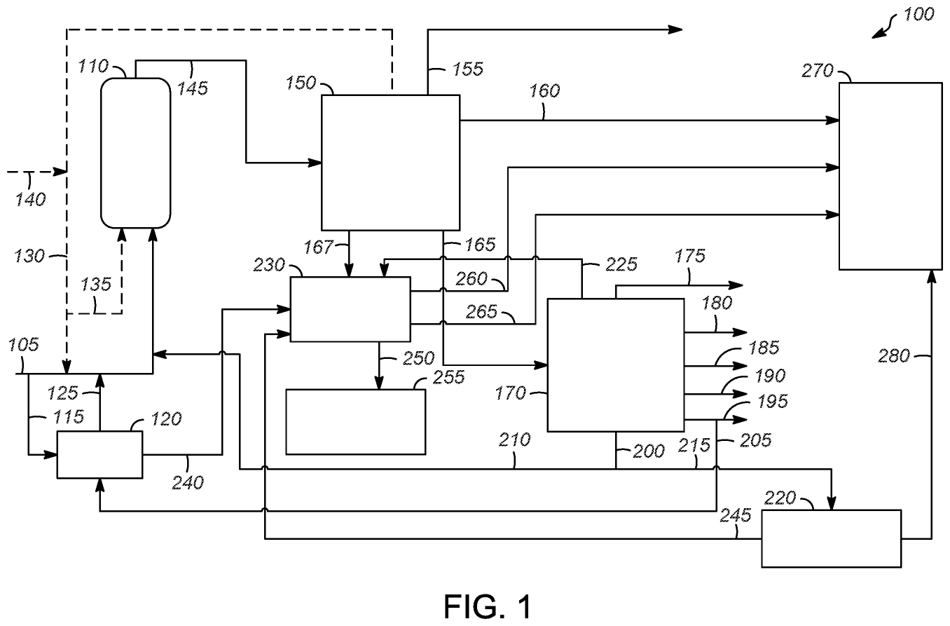

FIG. 1 is an illustration of a conventional slurry hydrocracking (SHC) process 100. The slurry hydrocracking (SHC) feed stream 105 is sent to the SHC reaction section 110.

The SHC feed stream 105 may include hydrocarbons boiling from about 340° C. (644° F.) to about 570° C. (1058° F.), an atmospheric residue, a vacuum residue, visbreaker vacuum residue, vacuum gas oils, FCC slurry oils, tar, bitumen, coal oil, shale oil, and SDA pitch.

A portion 115 of the SHC feed stream 105 is sent to a catalyst section 120 where catalyst is mixed with the portion 115 of the SHC feed stream 105. Typically, the slurry catalyst composition can include a catalytically effective amount of one or more compounds having iron or molybdenum. Particularly, the one or more compounds can include at least molybdenum in hydrocarbon, on carbon or on a support or one of an iron oxide, an iron sulfate, and an iron carbonate. Other forms of iron can include at least one of an iron sulfide, a pyrrhotite, and a pyrite. The catalyst can contain materials such as at least one of nickel and/or molybdenum, and/or a salt, an oxide, and/or a mineral thereof. Iron compounds include an iron sulfate, such as an iron sulfate monohydrate and an iron sulfate heptahydrate. Alternatively, one or more catalyst particles can include about 2 to about 45 wt % iron oxide and about 20 to about 90 wt % alumina such as bauxite. In another exemplary embodiment, it may be desirable for the catalyst to be supported. Such a catalyst can include a support of alumina, silica, titania, one or more aluminosilicates, magnesia, bauxite, coal and/or petroleum coke. Such a supported catalyst can include a catalytically active metal, such as at least one of iron, molybdenum, nickel, and vanadium, as well as sulfides of one or more of these metals. Generally, supported catalyst can have about 0.01 to about 30 wt % of the catalytic active metal based on the total weight of the catalyst.

The mixed heavy hydrocarbon-catalyst stream 125 is combined with the SHC feed stream 105 and is sent to the SHC reaction section 110. Recycle hydrogen stream 130 can be introduced into SHC feed stream 105. A portion 135 of the recycle hydrogen stream 130 can be fed directly to the SHC reaction section 110. Make up hydrogen stream 140 can be added to the recycle hydrogen stream 130.

The SHC reaction section 110 can operate at any suitable conditions, such as a temperature of about 340 to about 600° C., a hydrogen partial pressure of about 3.5 to about 35 MPa, or 13.0 to 27 MPa, and an LHSV typically below about 4 hr⁻¹ on a fresh feed basis, or a range of about 0.05 to about 3 hr⁻¹, or a range of about 0.2 to about 1

hr⁻¹. Often, SHC is carried out using reactor conditions sufficient to crack at least a portion of the heavy hydrocarbon SHC feed stream 105 to products boiling lower than pitch, such as gas oil, diesel, naphtha, and C₁-C₄ products. The SHC reaction section 110 may include one or more SHC reactors and may operate to achieve an overall conversion of about 90 to about 99% conversion, preferably between about 92 and about 97 wt % conversion.

The reaction mixture 145 from the SHC reaction section 110 is sent to a separation section 150 where it is separated into the recycle hydrogen stream 130, a flash gas stream 155, a degassing drum vent gas stream 160, a liquid stream 165, and a sour water stream 167.

The liquid stream 165 is sent the fractionation section 170 where it is separated into various streams, including for example, a C₄₋ stream 175 (e.g., boiling point range of 38-45° C.), a naphtha stream 180 (e.g., boiling point range of 90-200° C.), a diesel stream 185 (e.g., boiling point range of 150-380° C.), a light vacuum gas oil (LVGO) stream 190 (e.g., boiling point range of 425-510° C.), a heavy vacuum gas oil (HVGO) stream 195 (e.g., boiling point range of 510-564° C.), and a SHC pitch stream 200 (e.g., boiling point above 538° C.). Other fractionation schemes could be used, as would be understood by those of skill in the art. A portion 205 of the HVGO stream 195 is sent to the catalyst section 120.

A portion 210 of the SHC pitch stream 200 is recycled to the SHC reaction section 110. A second portion 215 of the SHC pitch stream 200 is sent to a pitch treatment section 220. In the pitch treatment section 220, the SHC pitch can be processed for use in cement production, gasified, and/or treated for solids recovery. Sour water stream 225 from the fractionation section 170 is sent to a sour water stripper (SWS) system 230. Sour water stream 167 from the separation section 150, sour water stream 240 from the catalyst section 120, and sour water stream 245 from the pitch treatment section are sent to the SWS system 230.

A phenolic sour water stream 250 from the SWS system 230 is sent to a waste water treatment plant 255. A phenolic SWS tank vent gas stream 260 and a combined off-gas stream 265 (e.g., off-gas from a phenolic NH₃ stripper and off-gas from a phenolic sour water storage tank) from the SWS system 230 are sent to a thermal oxidizer section 270. The degassing drum vent gas stream 160 from the separation section 150 is sent to the thermal oxidizer section 270. Vent gas stream 280 from the pitch treatment section 220 is sent to the thermal oxidizer section 270.

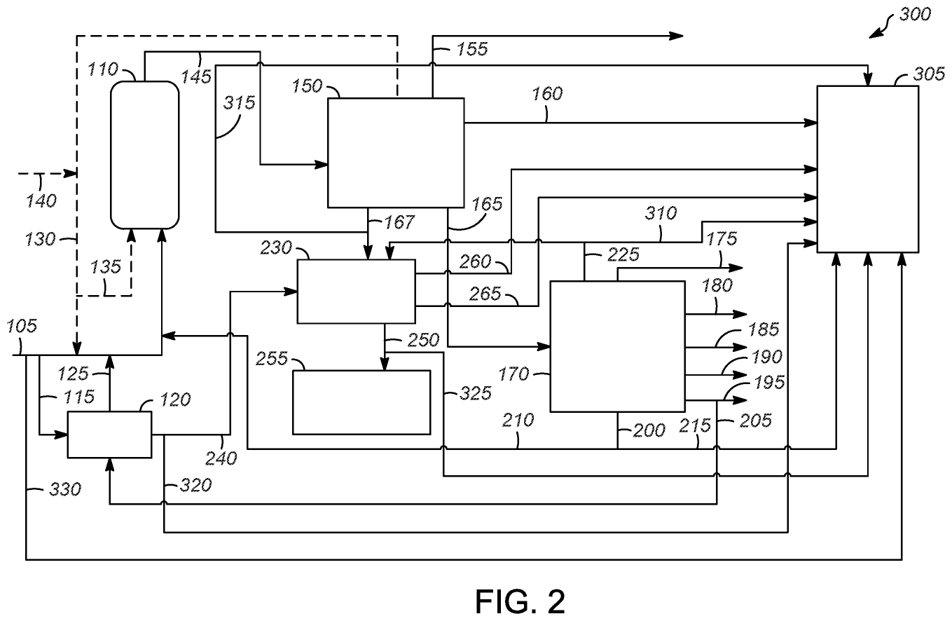

FIG. 2 illustrates a SHC process 300 according to the present invention. In this SHC process 300, the pitch treatment section 220 has been eliminated. The second portion 215 of the SHC pitch stream 200 from the fractionation section 170 is sent to a thermal oxidation system 305, which will be described below.

In some embodiments, one or more of the following streams can also be sent to the thermal oxidation system 305: all or a portion 310 of the sour water stream 225 from the fractionation section 170, all or a portion 315 of the sour water stream 167 from the separation section 150, all or a portion 320 of the sour water stream 240 from the catalyst section 120, and all or a portion 325 of the phenolic sour water stream 250 from the SWS system 230. If one or more of these sour water streams is sent to the thermal oxidation system 305, the size of the SWS system 230 and/or the waste water treatment plant 255 may be reduced, or, in some cases, completely eliminated.

In some cases, the size of heavy residue stream may not economically justify having a SHC process. In this situation, a heavy residue stream 330 can be sent directly to the thermal oxidation system 305.

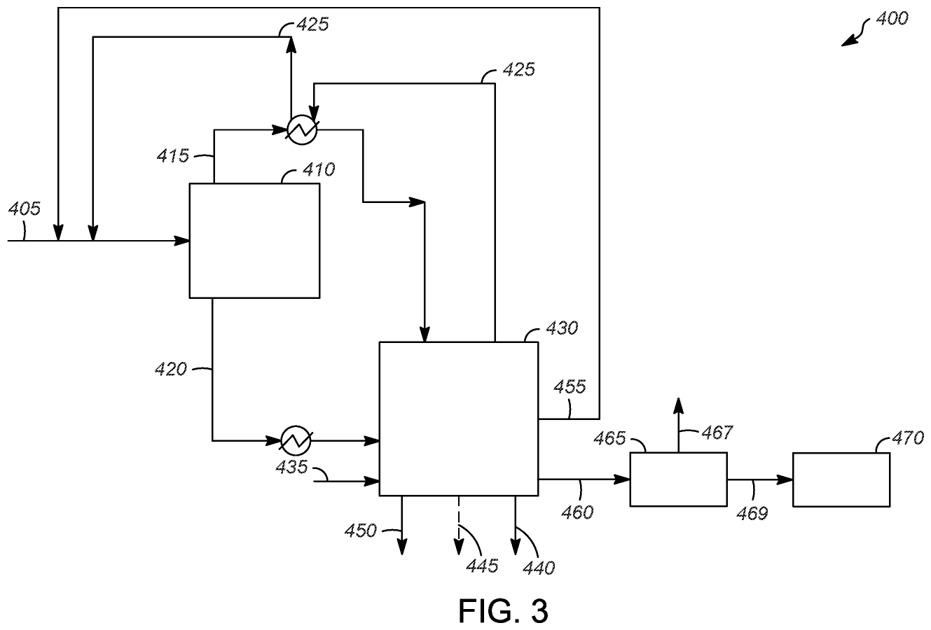

FIG. 3 is an illustration of a conventional SDA process 400. The SDA feed stream comprises vacuum residue or atmospheric residue. The SDA feed stream 405 is sent to the solvent extraction section 410 where it is separated into stream 415 comprising DAO, resin, and solvent and stream 420 comprising SDA pitch and solvent. Stream 415 is heat exchanged with recovered solvent stream 425 and sent to SDA separation section 430. Stream 420 is sent to SDA separation section 430, along with steam stream 435. Streams 415 and 420 are separated into DAO stream 440, optional resin stream 445, and SDA pitch stream 450. Recycled DAO wash stream 455 is combined with SDA feed stream 405 before mixing with recovered solvent stream 425. Sour water stream 460 from a low pressure (LP) solvent drum in the SDA separation section 430 is sent to SWS system 465. Acid gas stream 467 is sent to the refinery relief header. Stripped sour water stream 469 is sent to waste water treatment plant 470. SDA pitch stream 450 may be used in a high sulfur fuel oil blend or sent to a solid waste management facility for recovery of solid waste.

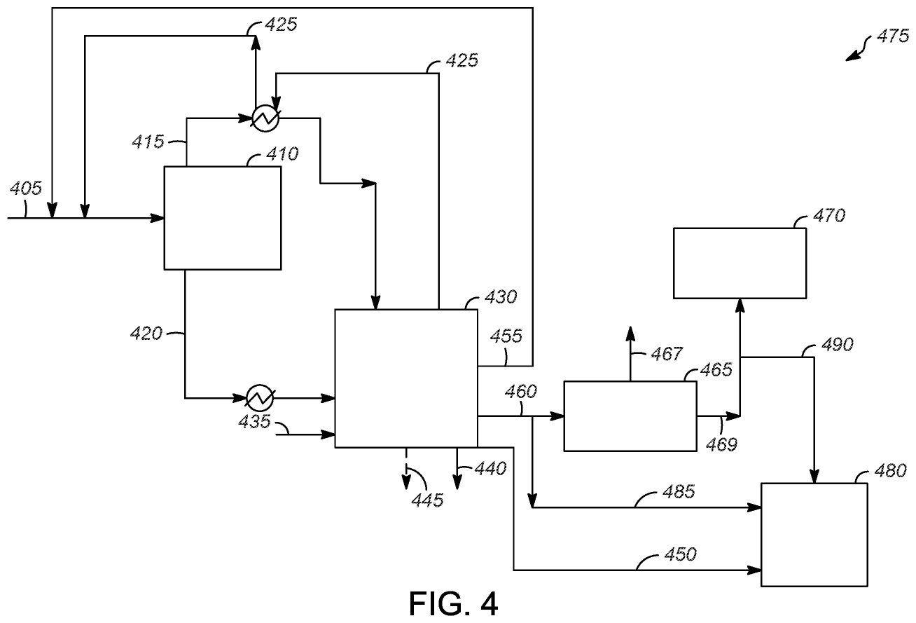

FIG. 4 illustrates the SDA process 475 of the present invention. In this process, the SDA pitch stream 450 is sent to the thermal oxidation system 480, which will be described below. All or a portion 485 of the sour water stream 460 from the SDA separation section 430 is sent to thermal oxidation system 480. All or a portion 490 of stripped sour water stream 469 from the SWS system 465 is sent to thermal oxidation system 480.

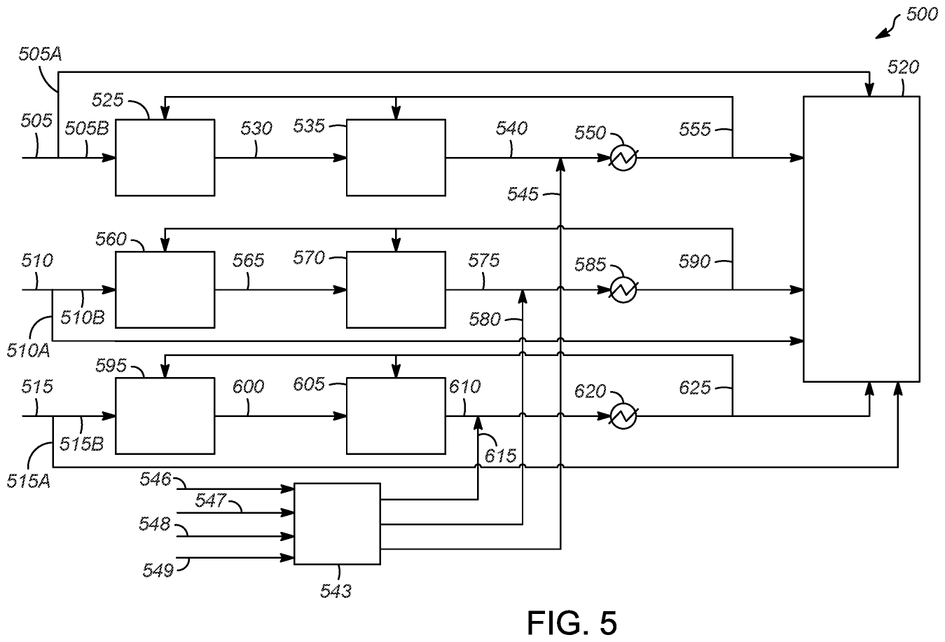

FIG. 5 illustrates one process 500 for treating the SHC pitch stream 505 (e.g. the second portion 215 of the SHC pitch stream 200 in FIG. 2), and/or the SDA pitch stream 510 (e.g., the SDA pitch stream 450 in FIG. 4), and/or the heavy residue stream 515 (e.g., heavy residue stream 330 in FIG. 2) before they are sent to the thermal oxidation system 520.

The SHC pitch stream 505, and/or SDA pitch stream 510, and/or heavy residue stream 515 need to be at an appropriate temperature because if they cool, they will solidify. In some embodiments, the SHC pitch stream 505, and/or the SDA pitch stream 510, and/or the heavy residue stream 515 can sent directly to the thermal oxidation system 520. In most cases, the SHC pitch stream 505, the SDA pitch stream 510, and the heavy residue stream 515 will need additional heating to allow atomization for introduction into the thermal oxidation system 520.

The SHC pitch stream 505A can sent directly to the thermal oxidation system 520 in some cases. Alternatively, the SHC pitch stream 505B can be sent to a heated SHC pitch storage vessel 525 to help maintain the temperature of the SHC pitch stream 505B. A heated SHC pitch stream 530 from the heated SHC pitch storage vessel 525 can be sent to a hot SHC pitch buffer vessel 535 where the temperature can be increased. A hot SHC pitch stream 540 from the hot SHC pitch buffer vessel 535 can be sent to the thermal oxidation system 520. A diluent stream 545 from diluent storage vessel 543 can be mixed with the hot SHC pitch stream 540 (or the SHC pitch stream 505A or 505B, or the heated SHC pitch stream 530), if desired. Suitable diluent includes, but is not limited to, a diesel stream (e.g., boiling point range of 150-380° C.) 546, light or heavy fluid catalytic cracking (FCC) oil stream (e.g., boiling point range of 340-540° C.) 547, kerosene stream (e.g., boiling point range of 150-300° C.) 458, and a heavy vacuum gas oil (HVGO) (e.g., boiling point range of 510-564° C.) stream 549. Additional heat can be supplied to the hot SHC pitch stream 540 if needed, for example, by an electric or fuel fired heater 550. A recycle hot SHC pitch stream 555 can be sent to the heated SHC pitch storage vessel 525, the hot SHC pitch buffer vessel 535, or both.

The SDA pitch stream 510A can sent directly to the thermal oxidation system 520 in some cases. Alternatively, the SDA pitch stream 510B can be sent to a heated SDA pitch storage vessel 560 to help maintain the temperature of the SDA pitch stream 510B. A heated SDA pitch stream 565 from the heated SDA pitch storage vessel 560 can be sent to a hot SDA pitch buffer vessel 570 where the temperature can be increased. A hot SDA pitch stream 575 from the hot SDA pitch buffer vessel 570 can be sent to the thermal oxidation system 520. A diluent stream 580 from the diluent storage vessel 547 can be mixed with the hot SDA pitch stream 575 (or the SDA pitch stream 510A or 510B, or the heated SDA pitch stream 565), if desired. Additional heat can be supplied the hot SDA pitch stream 575 if needed, for example, by an electric or fuel fired heater 585. A recycle hot SDA pitch stream 590 can be sent to the heated SDA pitch storage vessel 560, the hot SDA pitch buffer vessel 570, or both.

The heavy residue stream 515A can sent directly to the thermal oxidation system 520 in some cases. Alternatively, the heavy residue stream 515B can be sent to a heated heavy residue storage vessel 595 to help maintain the temperature of the heavy residue stream 515B. A heated heavy residue stream 600 from the heated heavy residue storage vessel 595 can be sent to a hot heavy residue buffer vessel 605 where the temperature can be increased. A hot heavy residue stream 610 from the hot heavy residue buffer vessel 605 can be sent to the thermal oxidation system 520. A diluent stream 615 from the diluent storage vessel 547 can be mixed with the hot heavy residue stream 610 (or the heavy residue stream 515A or 515B, or the heated heavy residue stream 600), if desired. Additional heat can be supplied the hot heavy residue stream 610 if needed, for example, by an electric or fuel fired heater 620. A recycle hot heavy residue stream 625 can be sent to the heated heavy residue storage vessel 595, the hot heavy residue buffer vessel 605, or both.

Although FIG. 5 shows the SHC pitch stream 505A, the hot SHC pitch stream 540, the SDA pitch stream 510, hot SDA pitch stream 575, the heavy residue stream 515, and hot heavy residue stream 610 being sent to the same thermal oxidation system, this is not required. One, two, or three could go to the thermal oxidation system 520, depending on the complex. Additionally, various gas and liquid stream would also be sent to the thermal oxidation system, as discussed below.

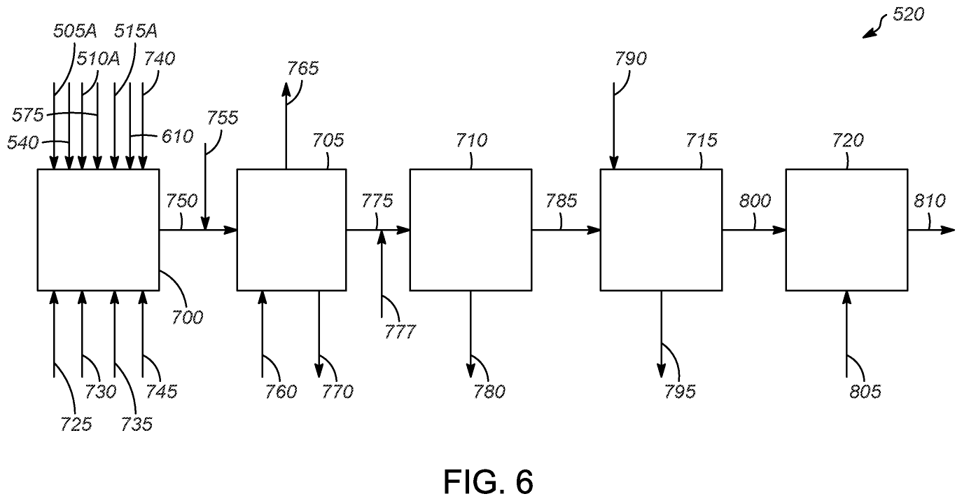

FIG. 6 illustrates one embodiment of the thermal oxidation system 520. The thermal oxidation system 520 comprises a thermal oxidizing section 700, a waste heat recovery section 705, a metal recovery filtration section 710, a quench and SOx removal section 715, and an optional NOx removal section 720.

As shown, FIG. 6 illustrates at least one of the SHC pitch stream 505A, the hot SHC pitch stream 540, the SDA pitch stream 510A, the hot SDA pitch stream 575, the heavy residue stream 515A, the hot heavy residue stream 610 (none of the associated waste gas or liquid streams are shown), along with combustion air stream 725, make-up natural gas or fuel gas stream 730, and quench stream 735 are introduced into the thermal oxidizing section 700. In some cases, atomizing stream 745 can also be introduced in the thermal oxidizing section 700. Suitable atomizing streams include, but are not limited to, air or steam.

For ease of understanding, the other waste gas and liquid streams are not shown in FIG. 6. For the embodiment of FIG. 2, at least one of degassing drum vent gas stream 160 from the separation section 150, phenolic SWS tank vent gas stream 260, combined off-gas stream 265 (e.g., off-gas from a phenolic NH₃ stripper and off-gas from a phenolic sour water storage tank from the SWS system 230), all or a portion 215 of the SHC pitch stream 200 from the fractionation section 170, heavy residue stream 330, all or a portion 325 of the phenolic sour water stream 250 from the SWS system 230, all or a portion 310 of the sour water stream 225 from the fractionation section 170, all or a portion 315 of the sour water stream 167 from the separation section 150, and all or a portion 320 of the sour water stream 240 from the catalyst section 120 would be introduced into the thermal oxidizing section 700. For the embodiment of FIG. 4, all or a portion 485 of the sour water stream 460 from the SDA separation section 430, all or a portion 490 of stripped sour water stream 469 from the SWS system 465, and SDA pitch stream 450 from SDA separation section 430 are introduced into the thermal oxidizing section 700.

The inlet temperature of the thermal oxidizing section 700 is typically in the range of −30-500° C. with a pressure of −1 kPa(g) to 3000 kPa(g). The outlet temperature is typically in the range of 650-1300° C. with a pressure of −1 kPa(g) to 50 kPa(g). The residence time in the thermal oxidizing section 700 is between 0.5 and 2 seconds. Any suitable thermal oxidizing section 700 could be used, including, but not limited to, an adiabatic thermal oxidizer chamber or a non-adiabatic direct fired boiler. The thermal oxidizing section 700 can be forced draft, induced draft, or a combination of both. An optional selective non-catalytic reduction (SNCR) section may be present in some cases. The inlet temperature of the SNCR section is typically in the range of 650-1300° C. with a pressure of −1 kPa(g) to 50 kPa(g). The outlet temperature is typically in the range of 650-1040° C. with a pressure of −1 kPa(g) to 50 kPa(g). The residence time in the SNCR section is between 0.2 and 1 seconds. The thermal oxidation step would be separated from the SNCR step via a choke wall in the vessel. The hydrocarbons are converted to H₂O and CO₂. The sulfides from the sulfur species (e.g. H₂S) present in feed are converted to oxidized sulfur SOx including, but not limited to, SO₂ and SO₃, and H₂O. The nitrogen from the nitrogen bound molecules (e.g. NH₃) present in the feed are converted to Nitrogen (N₂) and NOx, including but not limited to NO, NO₂.

The flue gas stream 750 from the thermal oxidizing section 700 consists essentially of one or more of H₂O, CO₂, N₂, O₂, SOx (i.e., SO₂ and SO₃ ), and NOx (i.e., NO and NO₂). “Consisting essentially of” means that one of more of the gases or vapors are present, and there are no other gases or vapors present which require treatment before being released to the atmosphere.

The flue gas stream 750 from the thermal oxidizing section 700 is quenched with quench stream 755. Quench stream 755 may comprise, but is not limited to, air, water, and recycled flue gas. The flue gas stream 750 should be cooled to a temperature below the lowest melting temperature of the metals in the oxidized metal particulate to avoid fouling the waste heat recovery section 705 with liquid metal oxides which would be condensing. By cooling below the melting point, the metal oxides will be in solid form and therefore will not foul waste heat recovery section 705. Table 1 below provides the melting points of a variety of metal oxides which may be present in the flue gas in a slurry hydrocracking process. The temperature is typically reduced from about 650-1300° C. to about 537-1187° C. The pressure is typically −4 kPa(g) to 50 kPa(g).

The flue gas stream 750 is sent to the waste heat recovery section 705. The inlet temperature of the waste heat recovery section 705 is typically in the range of 537-1187° C. with a pressure of −4 kPa(g) to 50 kPa(g). The outlet temperature is typically in the range of 200-400° C. with a pressure of −4 kPa(g) to 50 kPa(g). Suitable waste heat recovery apparatus and methods include, but are not limited to, a waste heat recovery boiler, including, but not limited to, a firetube boiler or a watertube boiler. Boiler feed water or oil stream 760 enters the waste heat recovery section 705 where a portion is converted to steam or hot oil stream 765, with the remainder exiting as blowdown water or oil stream 770. In some cases, the steam can be converted to electricity, for example using a steam turbine, if desired.

The recovered waste heat in steam or hot oil stream 765 can be in the form of low (e.g., less than 350 kPa(g)), medium (e.g., 350 kPa(g) to 1750 kPa(g)), or high (e.g., greater than 1750 kPa(g)) pressure saturated or superheated steam, hot oil, and/or electricity. The recovered heat can be used to provide heat to one or more pieces of equipment or process streams in the SHC or SDA complex. For example, the recovered waste heat in steam or hot oil stream 765 can be used in upstream processes, reboilers in the fractionation section of the SHC process, heat exchangers in the SHC process, pretreatment of the SHC pitch feed stream, the pitch stripper reboiler in the SDA separation section, the resin stripper reboiler in the SDA separation section, the deasphalted oil stripper reboiler in the SDA separation section, heaters for the pitch stream from the SHC or SDA pitch storage vessels or hot SHC or SDA pitch buffer vessels, or other areas of the plant, or for other heat requirements.

The flue gas stream 775 from the waste heat recovery section 705 flows to the optional metal recovery filtration section 710. The temperature of the flue gas stream 775 can optionally be reduced using a quench stream 777. Quench stream 777 may comprise, but is not limited to, air, water, and recycled flue gas. The oxidized metal particulate is captured in a particulate filter. Suitable particulate filters include, but are not limited to, bag filters, ceramic filters, electrostatic precipitators, and combinations thereof. Recovered metals stream 780 comprising oxidized metal particulate exits the metal recovery filtration section 710. In other embodiments, the oxidized metal particulate is captured in the SOx removal section 715.

The filtered flue gas stream 785 from the metal recovery filtration section 710 is sent to the SOx removal section 715 for removal of the SOx. The SOx removal section may comprise a quench section, a scrubbing section, and a filtration section. The inlet temperature of the quench section is typically in the range of 200-400° C. with a pressure of −41 kPa(g) to 50 kPa(g). The outlet temperature is typically in the range of 45-150° C. with a pressure of −41 kPa(g) to 50 kPa(g). The inlet temperature of the scrubbing section is typically in the range of 45-150° C. with a pressure of −42 kPa(g) to 50 kPa(g). The outlet temperature is typically in the range of 45-150° C. with a pressure of −43 kPa(g) to 50 kPa(g). For example, the scrubbing section may include a stream 790 comprising aqueous NaOH is introduced into the scrubbing section where it reacts with the SOx in the flue gas. An aqueous stream 795 containing aqueous Na₂SO₃ , Na₂SO₄, and exits the quench and SOx removal section 715. Alternatively, stream 790 could be an NH₃ based solution. The NH₃ reacts with the SOx to form (NH₄)₂SO₄. In this case, the aqueous stream 795 would include H₂O, and (NH₄)₂SO₄. If the optional metal recovery filtration section 710 is not present, oxidized metal particulate will also be removed here.

The de-SOx outlet flue gas stream 800 from the quench and SOx removal section 715 has a reduced level of SOx compared to the incoming filtered flue gas stream 785. The de-SOx outlet flue gas stream 800 comprises one or more of H₂O, CO₂, N₂, O₂, and NOx.

If NOx is present in the de-SOx outlet flue gas stream 800, the de-SOx outlet flue gas stream 800 is sent to the optional NOx removal section 720 to remove NOx. The inlet temperature of the NOx removal section 720 is typically in the range of 150-300° C. with a pressure of −44 kPa(g) to 50 kPa(g). The outlet temperature is typically in the range of 200-350° C. with a pressure of −44 kPa(g) to 50 kPa(g). The de-SOx outlet flue gas stream 800 may need to be heated to obtain the desired inlet temperature for the NOx removal section 720. For example, the NOx removal section 720 can be a selective catalytic reduction (SCR) section in which an ammonia and/or urea stream 805 are introduced into the SCR section where it reacts with the NOx and forms N₂ and H₂O. Any suitable SCR catalyst could be used, including but not limited to, ceramic carrier materials such as titanium oxide with active catalytic components such as oxides of base metals including vanadium, molybdenum, and tungsten, or an activated carbon based catalyst. The de-NOx outlet flue gas stream 810 comprises one or more of H₂O, CO₂, N₂, O₂.

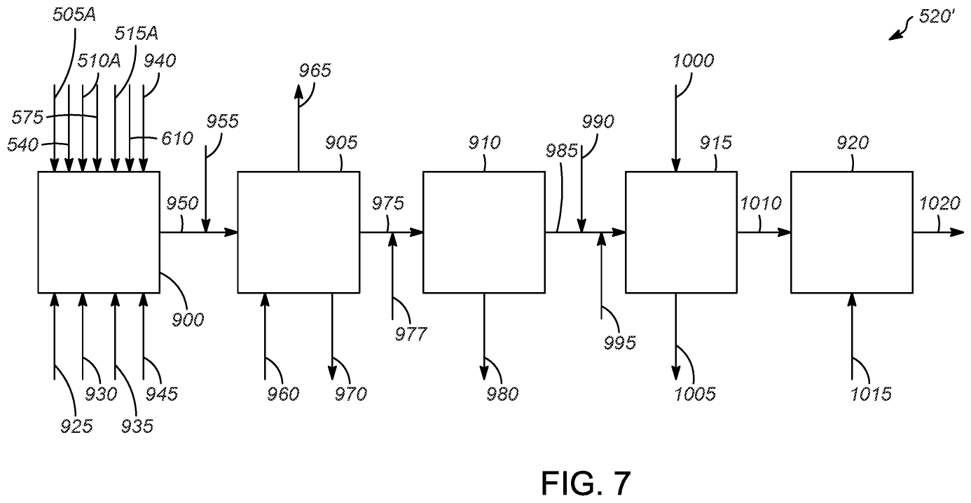

If the de-SOx outlet flue gas stream 800 does not contain NOx, the optional NOx removal section 720 is not present. The de-SOx outlet flue gas stream 800, consisting essentially of one or more of H₂O, CO₂, N₂, and O₂, can be vented to the atmosphere. Another embodiment of the thermal oxidation system 520′ is illustrated in FIG. 7. The thermal oxidation system 520′ comprises a thermal oxidizing section 900, a waste heat recovery section 905, a metal recovery filtration section 910, a SOx removal section 915, and an optional NOx removal section 920.

As shown, at least one of the SHC pitch stream 505A, the hot SHC pitch stream 540, the SDA pitch stream 510A, the hot SDA pitch stream 575, the heavy residue stream 515A, and the hot heavy residue stream 610, along with a combustion air stream 925, make-up natural gas or fuel gas stream 930, and quench stream 935 are introduced into the thermal oxidizing section 900. In some cases, atomizing stream 945 can also be introduced in the thermal oxidizing section 900. Suitable atomizing streams include, but are not limited to, air and/or steam. The appropriate streams for the embodiments shown in FIGS. 2 and 4 are described above.

The inlet temperature of the thermal oxidizing section 900 is typically in the range of −30-500° C. with a pressure of −1 kPa(g) to 3000 kPa(g). The outlet temperature is typically in the range of 650-1300° C. with a pressure of −1 kPa(g) to 50 kPa(g). The residence time in the thermal oxidizing section 900 is between 0.5 and 2 seconds. Any suitable thermal oxidizing section 900 could be used, including, but not limited to, an adiabatic thermal oxidizer chamber. The thermal oxidizing section 900 can be forced draft, induced draft, or a combination of both. The inlet temperature of the optional SNCR section is typically in the range of 650-1300° C. with a pressure of −1 kPa(g) to 50 kPa(g). The outlet temperature is typically in the range of 650-1040° C. with a pressure of −1 kPa(g) to 50 kPa(g). The residence time in the SNCR section is between 0.2 and 1 seconds. The thermal oxidation step would be separated from the SNCR step via a choke wall in the vessel.

The flue gas stream 950 from the thermal oxidizing section 900 comprises one or more of H₂O, CO₂, N₂, O₂, SOx, and NOx.

The flue gas stream 950 from the thermal oxidizing section 900 is quenched with quench stream 955. The temperature is reduced from 650-1300° C. to 537-1187° C. The pressure is typically −4 kPa(g) to 50 kPa(g).

The flue gas stream 950 is sent to the waste heat recovery section 905. Boiler feed water or oil stream 960 enters the waste heat recovery section 905 where a portion is converted to steam or hot oil stream 965, with the remainder exiting as blowdown water or oil 970. The inlet temperature of the waste heat recovery section 905 is typically in the range of 537-1187° C. with a pressure of −4 kPa(g) to 50 kPa(g). The outlet temperature is typically in the range of 200-400° C. with a pressure of −4 kPa(g) to 50 kPa(g). Suitable waste heat recovery apparatus and methods are described above. The recovered waste heat in steam or hot oil stream 965 can be in the form of low, medium, or high pressure saturated or superheated steam, hot oil, and/or electricity. The recovered waste heat in steam or hot oil stream 965 can be used in upstream processes, reboilers in the fractionation section of the SHC process, heat exchangers in the SHC process, pretreatment of the SHC pitch feed stream, the pitch stripper reboiler in the SDA separation section, the resin stripper reboiler in the SDA separation section, the deasphalted oil stripper reboiler in the SDA separation section, heaters for the pitch stream from the SHC or SDA pitch storage vessels or hot SHC or SDA pitch buffer vessels, or elsewhere in the plant, or for other heat requirements.

The flue gas stream 975 from the waste heat recovery section 905 flows to the optional metal recovery filtration section 910. The temperature of the flue gas stream 975 can optionally be reduced using a quench stream 977. Quench stream 977 may comprise, but is not limited to, air, water, and recycled flue gas. The oxidized metal particulate is captured in a particulate filter. Suitable particulate filters include, but are not limited to, bag filters, ceramic filters, electrostatic precipitators, and combinations thereof. Recovered metals stream 980 exits the metal recovery filtration section 910. If the metal recovery filtration section 910 is not present, the oxidized metal particles will be captured in the SOx removal section 915.

The filtered flue gas stream 985 from the metal recovery filtration section 910 (or flue gas stream 975 ) is sent to the SOx removal section 915 to convert SOx. The SOx removal section 915 can comprise a reaction section, a quench section and a filtration section. Fresh sorbent 990 and optionally recycled sorbent 995, (comprising a mixture of one or more Na₂CO₃, Na₂SO₄, CaSO₄, CaCO₃, MgCO₃, MgSO₄, and MgCO₃, depending on the compounds used in the reactant used, as discussed below) can be added to the filtered flue gas stream 985. The inlet temperature of the reaction section is typically in the range of 200-400° C. with a pressure of −6 kPa(g) to 50 kPa(g). The outlet temperature is typically in the range of 200-400° C. with a pressure of −6 kPa(g) to 50 kPa(g). For example, the reaction section may contain a reactant, such as NaHCO₃, NaHCO₃.Na₂CO₃.2 (H₂O), CaCO₃, Ca(OH)₂, and Mg(OH)₂, which reacts with the SOx, NOx and to form Na₂CO₃, Na₂SO₄, NaNO₃, CaSO₄, CaCO₃, MgCO₃, MgSO₄ and Mg(NO₃)₂. The reaction section flue gas comprises one or more of H₂O, CO₂, N₂, O₂, Na₂CO₃, Na₂SO₄, NaNO₃, CaSO₄, CaCO₃, Ca(NO₃)₂, MgCO₃, MgSO₄, Mg(NO₃)₂, and NOx. If the optional metal recovery filtration section 910 is not present, oxidized metal particulate will also be removed here.

The quench section of the SOx removal section 915 has an inlet temperature typically in the range of 200-400° C. with a pressure of −7 kPa(g) to 50 kPa(g). The outlet temperature is typically in the range of 150-350° C. with a pressure of 8 kPa(g) to 50 kPa(g). There is a filtration section for removal of the Na₂CO₃, Na₂SO₄, NaNO₃, CaSO₄, CaCO₃, Ca(NO₃)₂ MgCO₃, MgSO₄ and Mg(NO₃)₂. The inlet temperature of the filtration section is typically in the range of 150-350° C. with a pressure of −9 kPa(g) to 50 kPa(g). The outlet temperature is typically in the range of 150-350° C. with a pressure of −9 kPa(g) to 50 kPa(g). The filtration section comprises a bag filter, and/or a ceramic filter, and/or an electrostatic precipitator. An instrument air purge or high voltage DC 1000 is introduced into the metal recovery filtration section 910. In the case of the instrument air purge, it purges the retained material from the filter. In the case of the high voltage stream, it charges the cathodes of the ESP. The particulate is removed from the ESP by vibration. Dry residue stream 1005 comprising one or more of Na₂CO₃, Na₂SO₄, NaNO₃, CaSO₄, Ca₂CO₃, Ca(NO₃)₂ MgCO₃, MgSO₄, and Mg(NO₃)₂ exits the SOx removal section 915. The filtered flue gas stream 1010 consists essentially of one or more of H₂O, CO₂, N₂, O₂, and NOx.

If NOx is present in the filtered flue gas stream 1010, the filtered flue gas stream 1010 is sent to the optional NOx removal section 920 to remove NOx as discussed above. The inlet temperature of the NOx removal section 920 is typically in the range of 150-300° C. with a pressure of −10 kPa(g) to 50 kPa(g). The outlet temperature is typically in the range of 200-350° C. with a pressure of −10 kPa(g) to 50 kPa(g). For example, the NOx removal section 920 can be a selective catalytic reduction (SCR) section in which an ammonia and/or urea stream 1015 are introduced into the SCR section where it reacts with the NOx and forms N₂ and H₂O. Any suitable SCR catalyst could be used, including but not limited to, ceramic carrier materials such as titanium oxide with active catalytic components such as oxides of base metals including vanadium, molybdenum, and tungsten, or an activated carbon based catalyst. The de-NOx outlet flue gas stream 1020 consists essentially of one or more of H₂O, CO₂, N₂, and O₂.

If the filtered flue gas stream 1010 does not contain NOx, the optional NOx removal section 920 are not present. The filtered flue gas stream 1010, consisting essentially of one or more of H₂O, CO₂, N₂, and O₂, can be vented to the atmosphere.

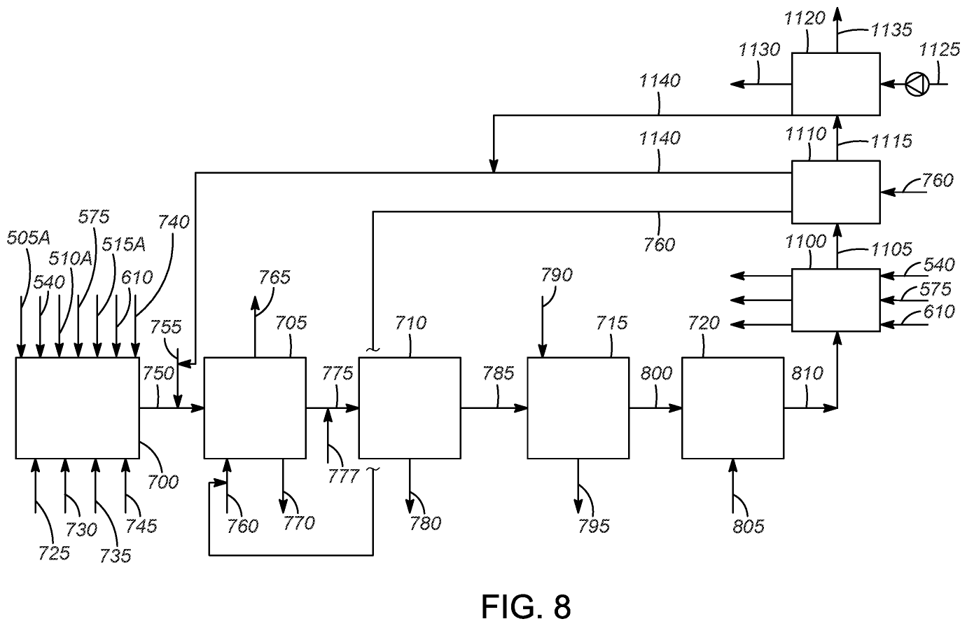

FIG. 8 illustrates an embodiment of the thermal oxidation system 520 of FIG. 6 with improved energy and water recovery. In this embodiment, energy and water can be recovered from the de-NOx outlet flue gas stream 810 by condensing the water in the de-NOx outlet flue gas stream 810. The condensate stream can be used as quench or process water for other parts of the process, in some cases after treatment like neutralization and/or deaeration and/or filtration.

The de-NOx outlet flue gas stream 810 may be sent to an optional pitch heat exchanger 1100. One or more of the hot SHC pitch stream 540 from the hot SHC pitch buffer vessel 535, the hot SDA pitch stream 575 from the hot SDA pitch buffer vessel 570, and the hot heavy residue stream 610 from the hot heavy residue buffer vessel 605 can be heated using the de-NOx outlet flue gas stream 810, replacing and/or supplementing the electric or fuel fired heaters 550, 585, and 625, thereby enabling additional pitch viscosity control.

The third cooled exhaust vapor stream 1105 from the optional pitch heat exchanger 1100 may be sent to the second side of a primary heat exchanger 1110.

Cold boiler feed water or oil stream 760 is passed through the first side of the primary heat exchanger 1110. There can be one or more primary heat exchangers 1110. Cold boiler feed water or oil stream 760 can be compressed in a pump and/or compressor from a pressure of about 0-75 psig to a pressure of about 100-400 psig, for example, before it is introduced into the primary heat exchanger 1110 to avoid flashing in the primary heat exchanger 1110.

Entering the primary heat exchanger 1110, the third cooled exhaust vapor stream 1105 has a temperature above the dew point. The heat exchange with the cold boiler feed water or oil stream 760 lowers the temperature of the third cooled exhaust vapor stream 1105. In some cases, the temperature will be lowered to a temperature at or below the dew point which results in condensation of the moisture out of the third cooled exhaust vapor stream 1105. The resulting cooled exhaust vapor stream 1115 can be sent to an exhaust stack and released to the atmosphere.

In other cases, the temperature will not be lowered sufficiently to condense water (any, most, or all) from the third cooled exhaust vapor stream 1105. In this case, an optional second heat exchanger 1120 can be used to lower the temperature of the cooled exhaust vapor stream 1115 to a temperature at or below the dew point leading to the formation of water condensate. The cooling medium 1125 for the second heat exchanger 1120 can be cold/ambient air or cold water, for example. The heated air or water 1130 can be used in other processed and/or released to the atmosphere. The second cooled stream 1135 can be released to the atmosphere.

The water condensate is recovered and exits the primary heat exchanger 1110 and/or the second heat exchanger 1120 as condensate stream 1140. Condensate stream 1140 can be used as all or a portion of quench stream 755 or in other processes.

The heated boiler feed water or oil stream 760 is sent to the waste heat recovery section 705.

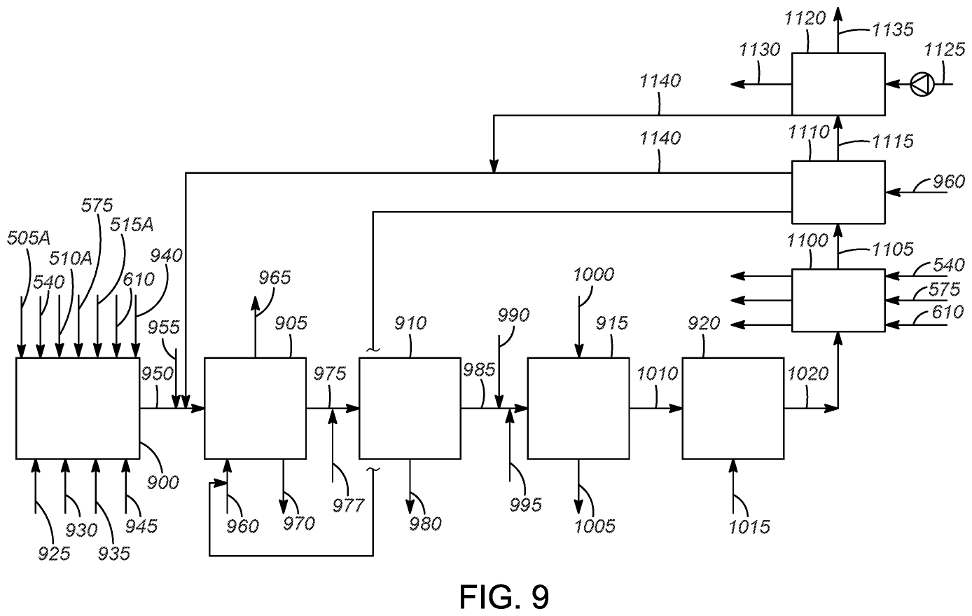

As the pitch heat exchanger 1100 is optional, it could be omitted, and the de-NOx outlet flue gas stream 810 could go directly to the primary heat exchanger 1110. FIG. 9 illustrates an embodiment of the thermal oxidation system 520′ of FIG. 7 with improved energy and water recovery. In this embodiment, the de-NOx outlet flue gas stream 1020 is sent to the optional pitch heat exchanger 1100. The third cooled exhaust vapor stream 1105 from the pitch heat exchanger 1100 is sent to the second side of the primary heat exchanger 1110, and the cold boiler feed water or oil stream 960 is passed through the first side of the primary heat exchanger 1110.

Entering the primary heat exchanger 1110, the third cooled exhaust vapor stream 1105 has a temperature above the dew point. The heat exchange with the cold boiler feed water or oil stream 960 lowers the temperature of the third cooled exhaust vapor stream 1105. In some cases, the temperature will be lowered to a temperature at or below the dew point which results in condensation of the moisture out of the third cooled exhaust vapor stream 1105. The resulting cooled exhaust vapor stream 1115 can be sent to an exhaust stack and released to the atmosphere.

In other cases, the temperature will not be lowered sufficiently to condense water (any, most, or all) from the third cooled exhaust vapor stream 1105. In this case, an optional second heat exchanger 1120 can be used to lower the temperature of the cooled exhaust vapor stream 1115 to a temperature at or below the dew point leading to the formation of water condensate. The cooling medium 1125 for the second heat exchanger 1120 can be cold/ambient air or cold water, for example. The heated air or water 1130 can be used in other processed and/or released to the atmosphere. The second cooled stream 1135 can be released to the atmosphere.

The water condensate is recovered and exits the primary heat exchanger 1110 and/or the second heat exchanger 1120 as condensate stream 1140. Condensate stream 1140 can be used as all or a portion of quench stream 755 or in other processes.

The heated boiler feed water or oil stream 960 is sent to the waste heat recovery section 705.

As the pitch heat exchanger 1100 is optional, it could be omitted, and the de-NOx outlet flue gas stream 1020 could go directly to the primary heat exchanger 1110.

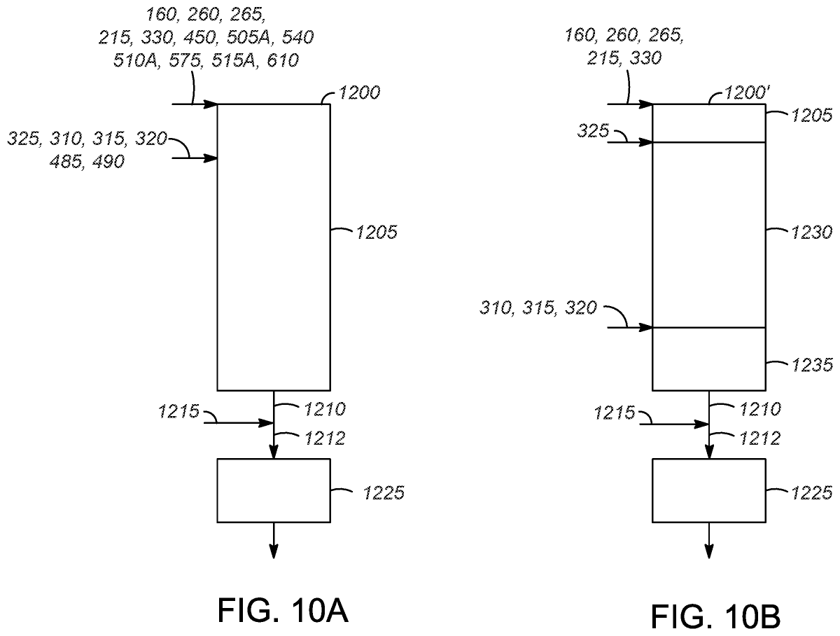

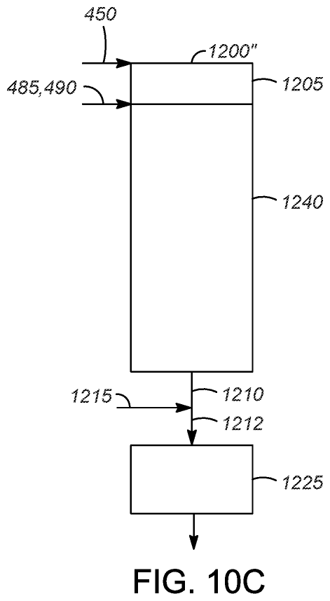

FIGS. 10A, 10B, and 10C illustrate different embodiments of a thermal oxidizing section and downstream waste heat recovery. Other sections of the thermal oxidation system including the SOx recovery section and the optional NOx recovery section are not shown, as the objective is to illustrate the different temperature profiles of the thermal oxidation system and how this can lead to reduced utility requirements.

In FIG. 10A, the thermal oxidizing section 1200 comprises a single high temperature section 1205 having a minimum temperature needed to combust the compounds in the various streams (e.g., about 980° C.). Gaseous waste streams, (e.g., degassing drum vent gas stream 160 from the separation section 150, phenolic SWS tank vent gas stream 260, and combined off-gas stream 265 (e.g., off-gas from a phenolic NH₃ stripper and off-gas from a phenolic sour water storage tank) from the SWS system 230), hydrocarbon liquid streams (e.g., the second portion 215 of the SHC pitch stream 200, heavy residue stream 330, SDA pitch stream 450 from SDA separation section 430, SHC pitch stream 505A, hot SHC pitch stream 540 from the hot SHC pitch buffer vessel 535, SDA pitch stream 510A, hot SDA pitch stream 575 from the hot SDA pitch buffer vessel 570, heavy residue stream 515A, and hot heavy residue stream 610 from the hot heavy residue buffer vessel 605), phenolic waste water streams (e.g., all or a portion 325 of the phenolic sour water stream 250 from the SWS system 230), and non-phenolic waste water streams (e.g. all or a portion 310 of the sour water stream 225 from the fractionation section 170, all or a portion 315 of the sour water stream 167 from the separation section 150, all or a portion 320 of the sour water stream 240 from the catalyst section 120, all or a portion 485 of the sour water stream 460 from the SDA separation section 430, all or a portion 490 of stripped sour water stream 469 from the SWS system 465) are all introduced at the first end of the high temperature section 1205. As discussed previously, these streams have different incoming temperatures, and some or all may need to be pre-heated.

The temperature of the high temperature section 1205 is maintained at or above the minimum temperature to combust the compounds in the various waste streams. The conditions are determined by the constituent auto ignition temperature (AIT). For example, cumene hydroperoxide has an AIT of 148° C., cumene has an AIT of 424° C., phenol has an AIT of 715° C., and benzene has an AIT of 560° C. The temperature for efficient oxidation is generally about 93° C. to about 260° C. above the AIT of the most difficult to oxidize organic compound in the waste stream. The destruction efficiency of volatile organic compounds (VOC) is a function of temperature and residence time.

For example, at 149° C. above AIT and 0.5 s residence time, the destruction efficiency is 95%. At 204° C. above AIT and 0.5 s residence time, the destruction efficiency is 98%. At 246° C. above AIT and 0.75 s residence time, the destruction efficiency is 99%. At 288° C. above AIT and 1.0 s residence time, the destruction efficiency is 99.9%. At 343° C. and 2.0 s residence time, the destruction efficiency is 99.99%.

The flue gas stream 1210 exiting the high temperature section 1205 is at or above the minimum temperature. If the sulfur salts are at too high a temperature, they can foul the waste heat recovery section 1225. Therefore, a quench stream 1215 of water, air, and/or recycled flue gas is used to reduce the temperature of the flue gas stream 1210 to a temperature below the temperature that the salts in the flue gas condense (e.g., less than about 704° C.-720° C.). The cooled flue gas stream 1220 is then sent to the waste heat recovery section 1225 and on to the rest of the thermal oxidation system.

The thermal oxidizing section of FIG. 10B can be used with the SHC process shown in FIG. 2. In FIG. 10B, the thermal oxidizing section 1200′ includes a high temperature section 1205, a medium temperature section 1230, and a low temperature section 1235.

Gaseous waste streams, (e.g., degassing drum vent gas stream 160 from the separation section 150, phenolic SWS tank vent gas stream 260, combined off-gas stream 265 (e.g., off-gas from a phenolic NH₃ stripper and off-gas from a phenolic sour water storage tank) from the SWS system 230) and hydrocarbon liquid streams (e.g., all or a portion 215 of the SHC pitch stream 200 from the fractionation section 170, and heavy residue stream 330) are introduced at the first end of the high temperature section 1205. The high temperature section 1205 has the minimum temperature to combust the compounds in the gaseous waste streams and hydrocarbon liquid streams (e.g., about 980° C.).

The phenolic waste water streams (e.g., all or a portion 325 of the phenolic sour water stream 250 from the SWS system 230) are introduced at the second end of the high temperature section 1205. The phenolic waste water streams reduce the temperature of the flue gas, and the medium temperature section 1230 has a lower temperature than the high temperature section 1205. The medium temperature section 1030 has a minimum temperature to ensure destruction of the phenolic compounds (e.g., about 900° C.). The medium temperature section 1230 is maintained at or above the minimum temperature.

The non-phenolic waste water streams (e.g. all or a portion 310 of the sour water stream 225 from the fractionation section 170, all or a portion 315 of the sour water stream 167 from the separation section 150, and all or a portion 320 of the sour water stream 240 from the catalyst section 120) are introduced at the second end of the medium temperature section 1230 which reduces the temperature of the flue gas further. The low temperature section 1235 has a minimum temperature for combustion of the non-phenolic compounds (e.g., of about 788° C.). The low temperature section 1235 is maintained at or above the minimum temperature.

The flue gas stream 1210 exiting the low temperature section 1235 is at the minimum temperature of the low temperature section 1035 (e.g., about 788° C.). A quench stream 1215 of water, air, and/or recycled flue gas is used to reduce the temperature of the flue gas stream 1210 to a temperature below the temperature that the salts in the flue gas condense (e.g., less than about 704-720° C.). The cooled flue gas stream 1220 is then sent to the waste heat recovery section 1225 and on to the rest of the thermal oxidation system.

The thermal oxidizing section of FIG. 10C could be used with the SDA process shown in FIG. 4. The thermal oxidizing section 1200′ includes a high temperature section 1205 and a medium temperature section 1240.

SDA pitch stream 450 from SDA separation section 430 is introduced at the first end of the high temperature section 1205. The high temperature section 1205 has the minimum temperature to combust the compounds in the hydrocarbon liquid stream (e.g., about 980° C.).

All or a portion 485 of the sour water stream 460 from the SDA separation section 430, and all or a portion 490 of stripped sour water stream 469 from the SWS system 465 are introduced at the second end of the high temperature section 1205 which reduces the temperature of the flue gas.

The flue gas stream 1210 exiting the medium temperature section 1240 is at the minimum temperature of the medium temperature section 1040 for combustion of the non-phenolic compounds (e.g., about 788° C.). A quench stream 1215 of water, air, and/or recycled flue gas is used to reduce the temperature of the flue gas stream 1210 to a temperature below the temperature that the salts in the flue gas condense (e.g., less than about 704-720° C.). The cooled flue gas stream 1220 is then sent to the waste heat recovery section 1225 and on to the rest of the thermal oxidation system.

### EXAMPLE

Table 1 provides the melting point for a variety of metal oxides that can be found in the flue gas from a slurry hydrocracking process.

TABLE 1

| COMPONENT | MELTING POINT (F.) |
|---|---|
| Vanadium Oxide, VO2 | 3573 |
| Aluminum Oxide, Al203 | 3762 |
| Iron Oxide, Fe203 | 2849 |
| Calcium Oxide, CaO | 4662 |
| Magnesium Oxide, MgO | 5166 |
| Molybdenum Dioxide, MoO2 | 2010 |
| Molybdenum Trioxide, MoO3 | 1476 |
| Sodium Oxide, Na2O | 2070 |
| Vanadium Pentoxide, V205 | 1274 |

Table 2 is a computer simulation illustrating the effect of different thermal oxidizing sections shown in FIGS. 10A-B.

For a thermal oxidizing section comprising a single high temperature section, the slurry hydrocracking pitch, gaseous waste streams, and sour water can be injected into the thermal oxidizing section for combustion. The combustion provides for complete disposal of the slurry hydrocracking pitch, while also converting the entrained metals into a metal oxide form for clean and easy recoverability downstream.

Due to combustion, the metals in the flue gas exiting the thermal oxidizing section are in vaporized/molten form. Therefore, the flue gas needs to be quenched below the lowest metal oxide melting point of the metals in the slurry hydrocracking effluent. Waste water streams can used to quench the flue gas exiting the thermal oxidizing section.

Table 2 compares processes using the thermal oxidizing sections illustrated in FIGS. 10A-B. It shows that for the same amount of gaseous and liquid wastes, the amount of make-fuel gas, and combustion air used was the same for the single high temperature section as shown in FIG. 10A and the thermal oxidizing section with high, medium and low temperature sections shown in FIG. 10B. However, the amount of quench water make-up used was less than half for the staged arrangement of FIG. 10B compared with the single high temperature thermal oxidizing section of FIG. 10A. In addition, the flue gas flow rate was significantly increased for the arrangement of FIG. 10B.

TABLE 2

| | Base Case | Optimization |
|---|---|---|
| | (No Quench | (Wastewater for |
| | Wastewater Offset) | Quench Offset) |
| Gaseous & Liquid | 60,386 | 60,386 |
| Wastes (lb/hr) | | |
| Make-up fuel gas (lb/hr) | 185 | 185 |
| Combustion air (lb/hr) | 63,238 | 63,238 |
| Quench water make-up | 88,200 | 40,793 |
| (lb/hr) | | |
| Flue gas flow rate (lb/hr) | 281,327 | 328,734 |
| Furnace Temperature (F.) | 1800 | 1800 |
| Quench Temperature (F.) | 1150 | 1150 |

As used herein, the terms “unit,” “zone,” and “section” can refer to an area including one or more equipment items as appropriate for the type of unit, zone, or section and/or one or more sub-zones or sub-sections. Equipment items can include, but are not limited to, one or more reactors or reactor vessels, separation vessels, adsorbent chamber or chambers, distillation towers, heaters, exchangers, pipes, pumps, compressors, and controllers. Additionally, an equipment item, such as a reactor, dryer, adsorbent chamber or vessel, can further include one or more sections, sub-sections, zones, or sub-zones.

### Specific Embodiments

While the following is described in conjunction with specific embodiments, it will be understood that this description is intended to illustrate and not limit the scope of the preceding description and the appended claims.

A first embodiment of the invention is a process for treating effluent streams in a process comprising thermally oxidizing at least one of a pitch stream from a slurry hydrocracking fractionation section, a pitch stream from a solvent deasphalting separation section, and a heavy residue stream in a thermal oxidation system, comprising thermally oxidizing the at least one of the pitch stream from the slurry hydrocracking fractionation section, the pitch stream from the solvent deasphalting separation section, and the heavy residue stream in a thermal oxidizing section forming flue gas consisting essentially of at least one of H₂O, CO₂, N₂, O₂, SOx, NOx, and oxidized metal particulate; recovering waste heat from the flue gas in a waste heat recovery section; optionally filtering the flue gas in the filtration section to remove the oxidized metal particulate forming a filtered flue gas and a particulate stream comprising the oxidized metal particulate; removing SOx from the flue gas or the filtered flue in a SOx removal section to form a de-SOx outlet flue gas consisting essentially of at least one of H₂O, CO₂, N₂, O₂, NOx, wherein removing the SOx from the flue gas comprises quenching the flue gas or the filtered flue gas to form quenched flue gas after recovering the waste heat; and contacting a caustic solution or an NH 3 based solution with the quenched flue gas in scrubbing section to form the de-SOx outlet flue gas and a liquid stream comprising at least one of H₂O, Na₂SO₃, Na₂SO₄, NaHSO₃, Na₂CO₃, and (NH₄)₂SO₄; or reacting the flue gas or the filtered flue gas with a reactant in an SOx reaction section to form a reaction section flue gas consisting essentially of at least one of H₂O, CO₂, N₂, O₂, Na₂CO₃, Na₂SO₄, NaNO₃, CaSO₄, CaCO₃, Ca(NO₃)₂, MgCO₃, MgSO₄, Mg(NO₃)₂, NOx, wherein the reactant comprises at least one of NaHCO₃, NaHCO₃.Na₂CO₃.2(H₂O), CaCO₃, Ca(OH)₂, and Mg(OH)₂; and filtering the reaction section flue gas in a filtration section to remove Na₂CO₃, Na₂SO₄, NaNO₃, CaSO₄, CaCO₃, Ca(NO₃)₂, MgCO₃, MgSO₄, and Mg(NO₃)₂ to form the de-SOx outlet flue gas and a dry residue stream comprising at least one of Na₂CO₃, Na₂SO₄, NaNO₃, CaSO₄, CaCO₃, Ca(NO₃)₂, MgCO₃, MgSO₄, and Mg(NO₃)₂, and optionally the oxidized metal particulate; optionally removing NOx from the de-SOx outlet flue gas in a NOx removal section to form a de-NOx outlet flue gas consisting essentially of at least one of H₂O, CO₂, N₂, and O₂. An embodiment of the invention is one, any or all of prior embodiments in this paragraph up through the first embodiment in this paragraph further comprising recovering at least one of the particulate stream from the filtration section and the dry residue stream from the SOx removal section. An embodiment of the invention is one, any or all of prior embodiments in this paragraph up through the first embodiment in this paragraph further comprising at least one of heating at least one of the pitch stream from the slurry hydrocracking fractionation section, the pitch stream from the solvent deasphalting separation section, and the heavy residue stream; introducing a diluent into at least one of the pitch stream from the slurry hydrocracking fractionation section, the pitch stream from the solvent deasphalting separation section, and the heavy residue stream; and atomizing at least one of the pitch stream from the slurry hydrocracking fractionation section, the pitch stream from the solvent deasphalting separation section, and the heavy residue stream. An embodiment of the invention is one, any or all of prior embodiments in this paragraph up through the first embodiment in this paragraph further comprising thermally oxidizing at least one of a sour water stream from a slurry hydrocracking separation section, a stripped sour water stream from the slurry hydrocracking separation section, a sour water stream from a catalyst addition section, a phenolic sour water stream from slurry hydrocracking sour water stripper system, a sour water stream from a slurry hydrocracking fractionation section, a sour water stream from a solvent deasphalting separation section, and a stripped sour water stream from a solvent deasphalting sour water stripping system into the thermal oxidizing section. An embodiment of the invention is one, any or all of prior embodiments in this paragraph up through the first embodiment in this paragraph further comprising at least one of; passing the pitch stream from the slurry hydrocracking fractionation section to a slurry hydrocracking storage vessel, and wherein thermally oxidizing the pitch stream from the slurry hydrocracking fractionation section comprises thermally oxidizing a heated pitch stream from a heated slurry hydrocracking storage vessel; passing the pitch stream from the solvent deasphalting separating section to a heated solvent deasphalting storage vessel, and wherein thermally oxidizing the pitch stream from the solvent deasphalting separation section comprises thermally oxidizing a heated pitch stream from a solvent deasphalting storage vessel; passing the heavy residue stream to a heated heavy residue storage vessel, and wherein thermally oxidizing the heavy residue stream comprises thermally oxidizing a heated heavy residue stream from the feed storage vessel. An embodiment of the invention is one, any or all of prior embodiments in this paragraph up through the first embodiment in this paragraph further comprising at least one of passing the heated pitch stream from the heated slurry hydrocracking storage vessel to a hot slurry hydrocracking pitch buffer vessel, and wherein thermally oxidizing the pitch stream from the slurry hydrocracking fractionation section comprises thermally oxidizing a hot pitch stream from the hot slurry hydrocracking pitch buffer vessel; passing the heated pitch stream from the heated solvent deasphalting storage vessel to a hot solvent deasphalting pitch buffer vessel, and wherein thermally oxidizing the pitch stream from the solvent deasphalting section comprises thermally oxidizing a hot pitch stream from the hot solvent deasphalting pitch buffer vessel; and passing the heated heavy residue stream from the heated heavy residue storage vessel to a hot heavy residue buffer vessel, and wherein thermally oxidizing the heavy residue stream comprises thermally oxidizing a hot heavy residue stream from the hot heavy residue buffer vessel. An embodiment of the invention is one, any or all of prior embodiments in this paragraph up through the first embodiment in this paragraph further comprising at least one of recycling a portion of the pitch stream from the hot slurry hydrocracking pitch buffer vessel to the slurry hydrocracking storage vessel, the hot slurry hydrocracking storage vessel, or both; recycling a portion of the pitch stream from the hot solvent deasphalting pitch buffer vessel to the solvent deasphalting pitch storage vessel, the hot solvent deasphalting pitch buffer vessel, or both; and recycling a portion of the heavy residue stream from the hot heavy residue buffer vessel to the heavy residue storage vessel, the hot heavy residue buffer vessel, or both. An embodiment of the invention is one, any or all of prior embodiments in this paragraph up through the first embodiment in this paragraph further comprising introducing at least one of ammonia and urea into a selective non-catalytic reduction section in the thermal oxidizing section to remove NOx, into the NOx removal section to remove NOx from the de-SOx outlet flue gas, or both. An embodiment of the invention is one, any or all of prior embodiments in this paragraph up through the first embodiment in this paragraph further comprising thermally oxidizing at least one of a degassing drum vent gas from a separation section of a slurry hydrocracking process, a phenolic SWS tank vent gas stream from a SWS system of the slurry hydrocracking process, and a combined off-gas stream from the SWS system of the slurry hydrocracking process. An embodiment of the invention is one, any or all of prior embodiments in this paragraph up through the first embodiment in this paragraph comprising thermally oxidizing the pitch stream from the slurry hydrocracking fractionation section, and further comprising introducing a feed stream containing a slurry hydrocracking catalyst into a slurry hydrocracking reaction section to produce a slurry hydrocracking effluent; separating the slurry hydrocracking effluent into a flash gas stream, a degassing vent gas stream, and a bottoms stream; fractionating the bottoms stream in the slurry hydrocracking fractionation section into a pitch stream and at least one of a naphtha stream, a diesel stream, a light vacuum gas oil stream, and a heavy vacuum gas oil stream; sending a first portion of the pitch stream to the thermal oxidation system, wherein thermally oxidizing the pitch stream from the slurry hydrocracking fractionation section comprises thermally oxidizing the first portion of the pitch stream; and optionally sending a second portion of the pitch stream to the slurry hydrocracking reaction section. An embodiment of the invention is one, any or all of prior embodiments in this paragraph up through the first embodiment in this paragraph comprising thermally oxidizing the pitch stream from the solvent deasphalting separation section, and further comprising separating a solvent deasphalting feed stream in an extraction section into a first stream comprising deasphalted oil, resin, and solvent and a second stream comprising solvent deasphalting pitch and solvent; separating the first stream and the second in a solvent deasphalting separation section into at least a pitch stream and a deasphalted oil stream; and sending the pitch stream to the thermal oxidizing section. An embodiment of the invention is one, any or all of prior embodiments in this paragraph up through the first embodiment in this paragraph further comprising introducing a sour water stream from the solvent deasphalting separation section into the thermal oxidizing section. An embodiment of the invention is one, any or all of prior embodiments in this paragraph up through the first embodiment in this paragraph further comprising passing a boiler feed water or oil stream through a first side of a primary heat exchanger; passing an exhaust vapor stream from the thermal oxidation system through a second side of the primary heat exchanger, wherein the exhaust vapor stream comprises the de-NOx outlet flue gas stream; transferring heat from the exhaust vapor stream to the boiler feed water or oil stream, cooling the exhaust vapor stream forming a cooled exhaust stream and heating the boiler feed water or oil stream forming a heated boiler feed water or oil stream; passing the heated boiler feed water or oil stream to the waste heat recovery section; and passing the cooled exhaust stream to an exhaust stack. An embodiment of the invention is one, any or all of prior embodiments in this paragraph up through the first embodiment in this paragraph further comprising passing a cooling stream through a first side of a secondary heat exchanger; passing the cooled exhaust vapor stream to a second side of the secondary heat exchanger to reduce a temperature of the cooled exhaust vapor stream and to heat the cooling stream and form a second cooled exhaust vapor stream and a heated stream. An embodiment of the invention is one, any or all of prior embodiments in this paragraph up through the first embodiment in this paragraph wherein the exhaust vapor stream is cooled in the primary heat exchanger to a temperature at or below a dew point to condense water from the exhaust vapor stream, forming a first condensate stream; and further comprising using the first condensate stream as at least a portion of a quench stream to cool the flue gas stream from the thermal oxidizing section to a temperature less than a lowest melting temperature of the oxidized metal particulate before it enters the waste heat recovery section. An embodiment of the invention is one, any or all of prior embodiments in this paragraph up through the first embodiment in this paragraph wherein the cooled exhaust vapor stream is passed to a secondary heat exchanger before being passed to the exhaust stack, and wherein the cooled exhaust vapor stream is further cooled in the secondary heat exchanger to a temperature at or below a dew point to condense water from the cooled exhaust vapor stream, forming a second condensate stream; and optionally, using the second condensate stream as at least a portion of a quench stream to cool the flue gas stream from the thermal oxidizing section to a temperature less than a lowest melting temperature of the oxidized metal particulate before it enters the waste heat recovery section

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for treating effluent streams in a process comprising:
thermally oxidizing at least one of a pitch stream from a slurry hydrocracking fractionation section, a pitch stream from a solvent deasphalting separation section, and a heavy residue stream in a thermal oxidation system, comprising:
thermally oxidizing the at least one of the pitch stream from the slurry hydrocracking fractionation section, the pitch stream from the solvent deasphalting separation section, and the heavy residue stream in a thermal oxidizing section forming flue gas consisting essentially of at least one of H₂O, CO₂, N₂, O₂, SOx, NOx, and oxidized metal particulate;
recovering waste heat from the flue gas in a waste heat recovery section;
optionally filtering the flue gas in the filtration section to remove the oxidized metal particulate forming a filtered flue gas and a particulate stream comprising the oxidized metal particulate;
removing SOx from the flue gas or the filtered flue in a SOx removal section to form a de-SOx outlet flue gas consisting essentially of at least one of H₂O, CO₂, N₂, O₂, NOx, wherein removing the SOx from the flue gas comprises:
quenching the flue gas or the filtered flue gas to form quenched flue gas after recovering the waste heat; and
contacting a caustic solution or an NH₃ based solution with the quenched flue gas in scrubbing section to form the de-SOx outlet flue gas and a liquid stream comprising at least one of H₂O, Na₂SO₃, Na₂SO₄, NaHSO₃, Na₂CO₃, and (NH₄)₂SO₄;
or
reacting the flue gas or the filtered flue gas with a reactant in an SOx reaction section to form a reaction section flue gas consisting essentially of at least one of H₂O, CO₂, N₂, O₂, Na₂CO₃, Na₂SO₄, NaNO₃, CaSO₄, CaCO₃, Ca(NO₃ )₂, MgCO₃, MgSO₄, Mg(NO₃ )₂, NOx, wherein the reactant comprises at least one of NaHCO₃, NaHCO₃.Na₂CO₃.2(H₂O), CaCO₃, Ca(OH)₂, and Mg(OH)₂; and
filtering the reaction section flue gas in a filtration section to remove Na₂CO₃, Na₂SO₄, NaNO₃, CaSO₄, CaCO₃, Ca(NO₃)₂, MgCO₃, MgSO₄, and Mg(NO₃)₂ to form the de-SOx outlet flue gas and a dry residue stream comprising at least one of Na₂CO₃, Na₂SO₄, NaNO₃, CaSO₄, CaCO₃, Ca(NO₃ )₂, MgCO₃, MgSO₄, and Mg(NO₃ )₂, and optionally the oxidized metal particulate;
optionally removing NOx from the de-SOx outlet flue gas in a NOx removal section to form a de-NOx outlet flue gas consisting essentially of at least one of H₂O, CO₂, N₂, and O₂.

2. The process of claim 1 further comprising:
recovering at least one of the particulate stream from the filtration section and the dry residue stream from the SOx removal section.

3. The process of claim 1 further comprising at least one of:
heating at least one of the pitch stream from the slurry hydrocracking fractionation section, the pitch stream from the solvent deasphalting separation section, and the heavy residue stream;
introducing a diluent into at least one of the pitch stream from the slurry hydrocracking fractionation section, the pitch stream from the solvent deasphalting separation section, and the heavy residue stream; and
atomizing at least one of the pitch stream from the slurry hydrocracking fractionation section, the pitch stream from the solvent deasphalting separation section, and the heavy residue stream.

4. The process of claim 1 further comprising:
thermally oxidizing at least one of a sour water stream from a slurry hydrocracking separation section, a stripped sour water stream from the slurry hydrocracking separation section, a sour water stream from a catalyst addition section, a phenolic sour water stream from slurry hydrocracking sour water stripper system, a sour water stream from a slurry hydrocracking fractionation section, a sour water stream from a solvent deasphalting separation section, and a stripped sour water stream from a solvent deasphalting sour water stripping system into the thermal oxidizing section.

5. The process of claim 1 further comprising at least one of;
passing the pitch stream from the slurry hydrocracking fractionation section to a slurry hydrocracking storage vessel, and wherein thermally oxidizing the pitch stream from the slurry hydrocracking fractionation section comprises thermally oxidizing a heated pitch stream from a heated slurry hydrocracking storage vessel;
passing the pitch stream from the solvent deasphalting separating section to a heated solvent deasphalting storage vessel, and wherein thermally oxidizing the pitch stream from the solvent deasphalting separation section comprises thermally oxidizing a heated pitch stream from a solvent deasphalting storage vessel; and
passing the heavy residue stream to a heated heavy residue storage vessel, and wherein thermally oxidizing the heavy residue stream comprises thermally oxidizing a heated heavy residue stream from the feed storage vessel.

6. The process of claim 5 further comprising at least one of:
passing the heated pitch stream from the heated slurry hydrocracking storage vessel to a hot slurry hydrocracking pitch buffer vessel, and wherein thermally oxidizing the pitch stream from the slurry hydrocracking fractionation section comprises thermally oxidizing a hot pitch stream from the hot slurry hydrocracking pitch buffer vessel;
passing the heated pitch stream from the heated solvent deasphalting storage vessel to a hot solvent deasphalting pitch buffer vessel, and wherein thermally oxidizing the pitch stream from the solvent deasphalting section comprises thermally oxidizing a hot pitch stream from the hot solvent deasphalting pitch buffer vessel; and
passing the heated heavy residue stream from the heated heavy residue storage vessel to a hot heavy residue buffer vessel, and wherein thermally oxidizing the heavy residue stream comprises thermally oxidizing a hot heavy residue stream from the hot heavy residue buffer vessel.

7. The process of claim 6 further comprising at least one of:
recycling a portion of the pitch stream from the hot slurry hydrocracking pitch buffer vessel to the slurry hydrocracking storage vessel, the hot slurry hydrocracking storage vessel, or both;
recycling a portion of the pitch stream from the hot solvent deasphalting pitch buffer vessel to the solvent deasphalting pitch storage vessel, the hot solvent deasphalting pitch buffer vessel, or both; and
recycling a portion of the heavy residue stream from the hot heavy residue buffer vessel to the heavy residue storage vessel, the hot heavy residue buffer vessel, or both.

8. The process of claim 1 further comprising:
introducing at least one of ammonia and urea into a selective non-catalytic reduction section in the thermal oxidizing section to remove NOx, into the NOx removal section to remove NOx from the de-SOx outlet flue gas, or both.

9. The process of claim 1 further comprising thermally oxidizing at least one of: a degassing drum vent gas from a separation section of a slurry hydrocracking process, a phenolic SWS tank vent gas stream from a SWS system of the slurry hydrocracking process, and a combined off-gas stream from the SWS system of the slurry hydrocracking process.

10. The process of claim 1 comprising thermally oxidizing the pitch stream from the slurry hydrocracking fractionation section, and further comprising:
introducing a feed stream containing a slurry hydrocracking catalyst into a slurry hydrocracking reaction section to produce a slurry hydrocracking effluent;
separating the slurry hydrocracking effluent into a flash gas stream, a degassing vent gas stream, and a bottoms stream;
fractionating the bottoms stream in the slurry hydrocracking fractionation section into a pitch stream and at least one of a naphtha stream, a diesel stream, a light vacuum gas oil stream, and a heavy vacuum gas oil stream;
sending a first portion of the pitch stream to the thermal oxidation system, wherein thermally oxidizing the pitch stream from the slurry hydrocracking fractionation section comprises thermally oxidizing the first portion of the pitch stream; and
optionally sending a second portion of the pitch stream to the slurry hydrocracking reaction section.

11. The process of claim 1 comprising thermally oxidizing the pitch stream from the solvent deasphalting separation section, and further comprising:
separating a solvent deasphalting feed stream in an extraction section into a first stream comprising deasphalted oil, resin, and solvent and a second stream comprising solvent deasphalting pitch and solvent;
separating the first stream and the second in a solvent deasphalting separation section into at least a pitch stream and a deasphalted oil stream; and
sending the pitch stream to the thermal oxidizing section.

12. The process of claim 11 further comprising:
introducing a sour water stream from the solvent deasphalting separation section into the thermal oxidizing section.

13. The process of claim 1 further comprising:
passing a boiler feed water or oil stream through a first side of a primary heat exchanger;
passing an exhaust vapor stream from the thermal oxidation system through a second side of the primary heat exchanger, wherein the exhaust vapor stream comprises the de-NOx outlet flue gas stream;
transferring heat from the exhaust vapor stream to the boiler feed water or oil stream, cooling the exhaust vapor stream forming a cooled exhaust stream and heating the boiler feed water or oil stream forming a heated boiler feed water or oil stream;
passing the heated boiler feed water or oil stream to the waste heat recovery section; and
passing the cooled exhaust stream to an exhaust stack.

14. The process of claim 13 further comprising:
passing a cooling stream through a first side of a secondary heat exchanger;
passing the cooled exhaust vapor stream to a second side of the secondary heat exchanger to reduce a temperature of the cooled exhaust vapor stream and to heat the cooling stream and form a second cooled exhaust vapor stream and a heated stream.

15. The process of claim 13 wherein the exhaust vapor stream is cooled in the primary heat exchanger to a temperature at or below a dew point to condense water from the exhaust vapor stream, forming a first condensate stream; and.
further comprising:
using the first condensate stream as at least a portion of a quench stream to cool the flue gas stream from the thermal oxidizing section to a temperature less than a lowest melting temperature of the oxidized metal particulate before it enters the waste heat recovery section.

16. The process of claim 13 wherein the cooled exhaust vapor stream is passed to a secondary heat exchanger before being passed to the exhaust stack, and wherein the cooled exhaust vapor stream is further cooled in the secondary heat exchanger to a temperature at or below a dew point to condense water from the cooled exhaust vapor stream, forming a second condensate stream; and
optionally, using the second condensate stream as at least a portion of a quench stream to cool the flue gas stream from the thermal oxidizing section to a temperature less than a lowest melting temperature of the oxidized metal particulate before it enters the waste heat recovery section.

17. The process of claim 1 further comprising:
passing at least one of the pitch stream from the slurry hydrocracking fractionation section, the pitch stream from the solvent deasphalting separation section, and the heavy residue stream through a first side of a pitch heat exchanger;
passing the exhaust vapor stream through a second side of the pitch heat exchanger before passing the exhaust vapor stream to the primary heat exchanger to reduce a temperature of the of the exhaust vapor stream and to heat the at least one of the pitch stream from the slurry hydrocracking fractionation section, the pitch stream from the solvent deasphalting separation section, and the heavy residue stream and form a third cooled exhaust vapor stream and at least one of a heated pitch stream from the slurry hydrocracking fractionation section, a heated pitch stream from the solvent deasphalting separation section, and a heated heavy residue stream;
passing the third cooled exhaust vapor stream to the primary heat exchanger; and
passing at least one of the heated pitch stream from the slurry hydrocracking fractionation section, the heated pitch stream from the solvent deasphalting separation section, and the heated heavy residue stream to the thermal oxidizing section of the thermal oxidation system.

18. The process of claim 1 wherein the thermal oxidizing section comprises a high temperature section and wherein at least one of the SHC pitch stream from the slurry hydrocracking fractionation section, hot SHC pitch stream from the hot SHC pitch buffer vessel, the pitch stream from the solvent deasphalting separation section, hot SDA pitch stream from the hot SDA pitch buffer vessel the heavy residue stream, hot heavy residue stream from the hot heavy residue buffer vessel degassing drum vent gas stream from the separation section, phenolic SWS tank vent gas stream, combined off-gas stream, all or a portion of the phenolic sour water stream from the SWS system, all or a portion of the sour water stream from the fractionation section, all or a portion of the sour water stream from the separation section, all or a portion of the sour water stream from the catalyst section, all or a portion of the sour water stream from the SDA separation section, all or a portion of stripped sour water stream from the SWS system, are introduced into the high temperature section and wherein the high temperature section has a minimum temperature for combustion of the at least one of the pitch stream from the slurry hydrocracking fractionation section, the pitch stream from the solvent deasphalting separation section, and the heavy residue stream.

19. The process of claim 1 wherein the thermal oxidizing section comprises a high temperature section, a medium temperature section, and a low temperature section, and wherein at least one of the pitch stream from the slurry hydrocracking fractionation section, and the hot SHC pitch stream from the hot SHC pitch buffer vessel are introduced into a first end of the high temperature section, and wherein the phenolic sour water stream from the SWS system is introduced at a second end of the high temperature section, and wherein at least one of all or a portion of a sour water stream from a fractionation section, all or a portion of a sour water stream from a separation section, and all or a portion of a sour water stream from a catalyst section, is introduced at the low temperature section, and wherein the high temperature section has a minimum temperature for combustion of the at least one of the pitch stream from the slurry hydrocracking fractionation section, the pitch stream from the solvent deasphalting separation section, and the heavy residue stream, wherein the medium temperature section has a minimum temperature for combustion of phenolic compounds, and wherein the low temperature section has a temperature for combustion of non-phenolic compounds.

20. The process of claim 1 wherein the thermal oxidizing section comprises a high temperature section and a medium temperature section, and wherein at least one of the pitch stream from the solvent deasphalting separation section and the hot SDA pitch stream from the hot SDA pitch buffer vessel are introduced into a first end of the high temperature section, and wherein all or a portion of the sour water stream from the SDA separation section, all or a portion of stripped sour water stream from the SWS system are introduced into the medium temperature section and wherein the high temperature section has a minimum temperature for combustion of the pitch stream from the solvent deasphalting separation section, and wherein the medium temperature section has a temperature for combustion of non-phenolic compounds.
